(19) United States
(12) Patent Application Publication
(10) Pub. No.: US 2003/0071428 A1
(43) Pub. Date: Apr. 17, 2003

(54) Golf bag wheeling cart

(76) Inventor: Bok- Sung Kang, Kyunggi-do (KR)

Correspondence Address: SNELL & WILMER, ONE ARIZONA CENTER, 400 EAST VAN BUREN, PHOENIX, AZ, 850040001

(21) Appl. No.: 10/051,446

(22) Filed: Jan. 18, 2002

(30) Foreign Application Priority Data
Oct. 12, 2001 (KR) 2001-62802

(51) Int. Cl. B62B 3/02; B62B 3/04

(52) U.S. Cl. 280/62; 280/47.34; 280/651

(57) ABSTRACT

Disclosed is a golf bag wheeling cart comprising a plate assembly for allowing a golf bag to be uprightly placed thereon, the plate assembly having a front plate and a rear plate which are connected with each other; a support assembly having a support rod which is erected on the rear plate such that the golf bag is fastened to and supported by the support rod; a front wheel section having a front wheel which is rotatably coupled to a front end of the front plate so that leftward and rightward cornering of the golf bag wheeling cart is allowed; a rear wheel section having a pair of rear wheels which are rotatably coupled to both sides, respectively, of a rear end of the rear plate; and a pulling assembly joined to the front wheel section for allowing the golf bag wheeling cart to be pulled.

### TECHNICAL FIELD

The present invention relates to a golf bag wheeling cart, and more particularly, the present invention relates to a golf bag wheeling cart, which has decreased volume and weight and at the same time accomplishes convenience upon use and stability upon movement.

### BACKGROUND ART

Generally, a pull-cart for transporting a golf bag is normally of a heavy construction, and therefore, in the case that a golfer or a caddie drives the pull-cart for an extended period of time, they become increasingly fatigued.

Also, the conventional pull-cart for transporting a golf bag occupies a large volume, and therefore, in the case that the pull-cart is moved using an automobile or stored in a place, a space utilization efficiency is deteriorated.

Further, since the conventional pull-cart for transporting a golf bag is configured in a manner such that it holds the golf bag in an inclined state, drivers, irons and putters are likely to lean to one side in the golf bag, whereby they may not be easily distinguished one from another and inconvenience can be caused upon taking them out of the golf bag.

### DISCLOSURE OF THE INVENTION

Accordingly, the present invention has been made in an effort to solve the problems occurring in the related art, and an object of the present invention is to provide a golf bag wheeling cart which is decreased in its volume, and thereby can be easily moved to a golf course and stored in a place.

Another object of the present invention is to provide a golf bag wheeling cart which is decreased in its weight and thereby can be conveniently used even by an old or a feeble person.

Another object of the present invention is to provide a golf bag wheeling cart which allows a golf bag to be uprightly mounted thereto, whereby drivers, irons and putters can be selected and used in an easy and convenient manner.

Still another object of the present invention is to provide a golf bag wheeling cart which is constructed in such a way as to be safely used.

Yet still another object of the present invention is to provide a golf bag wheeling cart which can be manufactured at a reduced cost.

In order to achieve the above objects, according to the present invention, there is provided a golf bag wheeling cart comprising: a foldable plate assembly; a support assembly erected on the plate assembly, having a plurality of telescopic pipes so that a length of the support assembly can be adjusted, and configured in a manner such that it can be collapsed onto an upper surface of the plate assembly; front and rear wheel sections having a front wheel and a pair of rear wheels which are rotatably coupled to front and rear ends of the plate assembly, respectively; and a pulling assembly joined to the front wheel section for allowing the golf bag wheeling cart to be pulled.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a golf bag wheeling cart in accordance with an embodiment of the present invention;

FIG. 2 is a perspective view illustrating a state wherein a golf bag is mounted to the golf bag wheeling cart according to the present invention;

FIG. 3 is a partial enlarged perspective view illustrating a rear wheel section of the golf bag wheeling cart according to the present invention;

FIG. 4 is a partial enlarged perspective view illustrating a front wheel section of the golf bag wheeling cart according to the present invention;

FIG. 5 is a front cross-sectional view illustrating the front wheel section of the golf bag wheeling cart according to the present invention; and

FIG. 6 is a perspective view illustrating a state wherein the golf bag wheeling cart according to the present invention is folded to be reduced in its size.

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

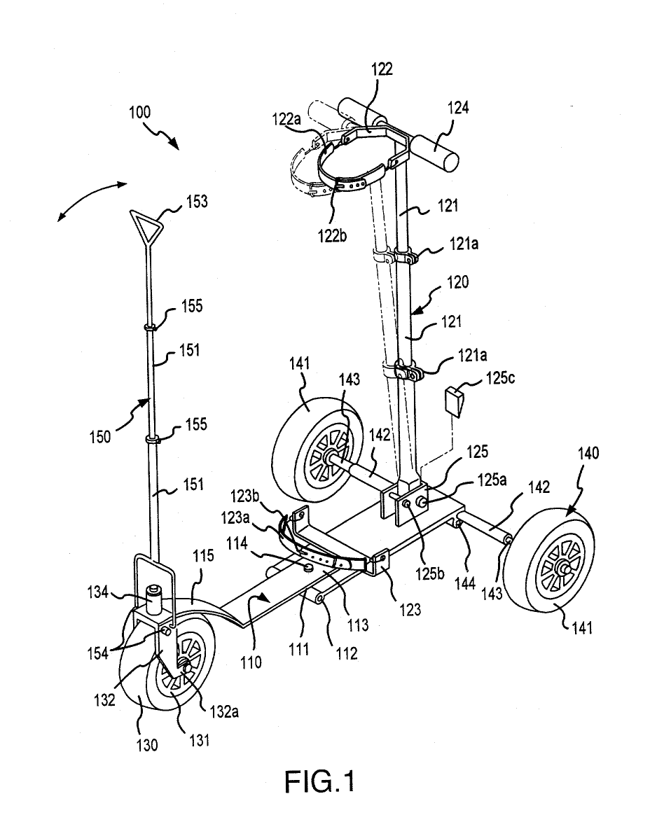

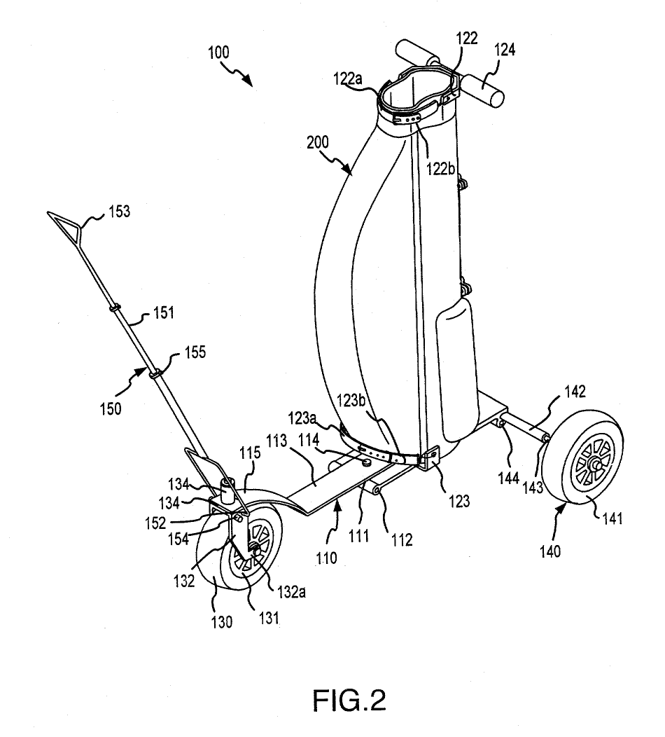

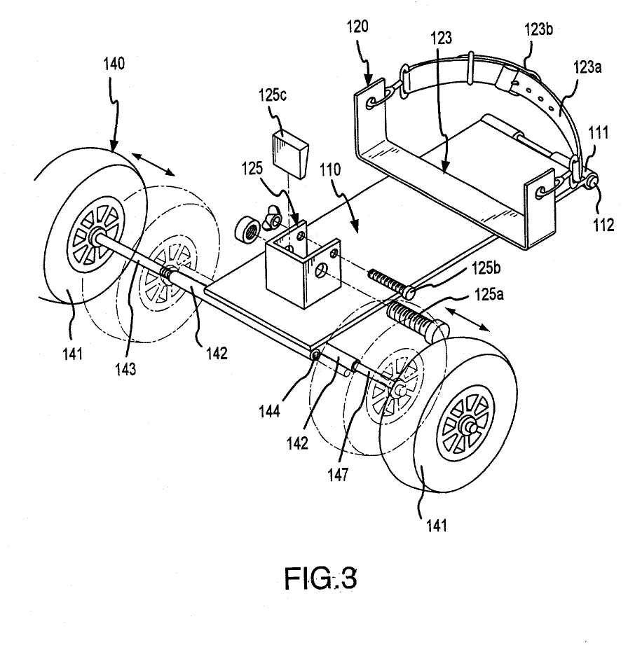

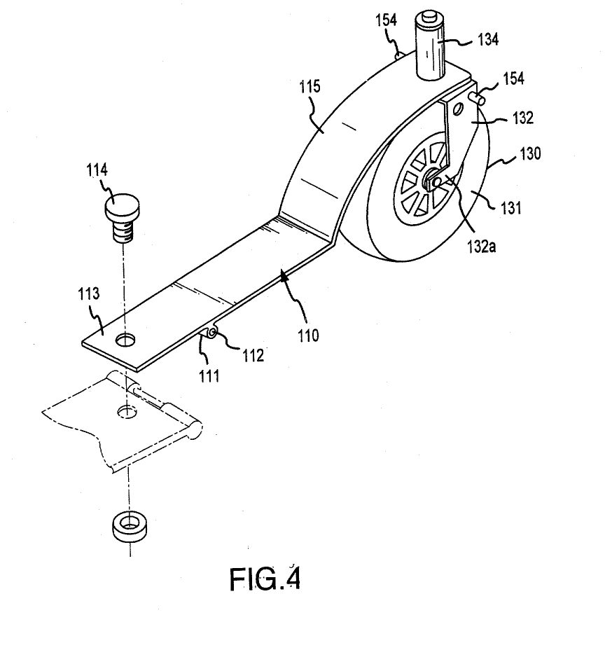

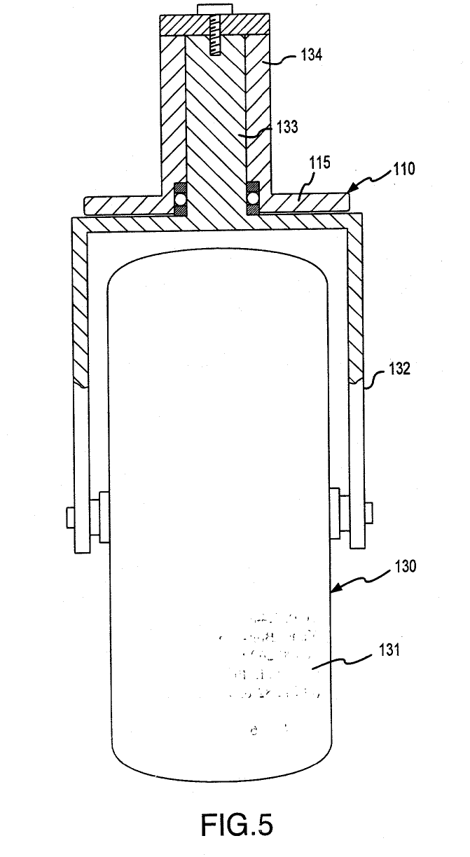

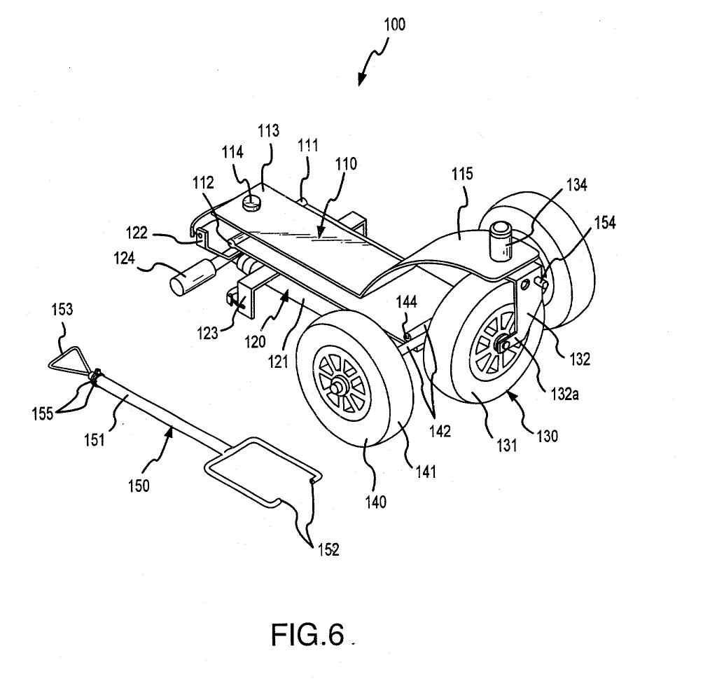

As shown in FIGS. 1 through 6, a golf bag wheeling cart 100 in accordance with an embodiment of the present invention includes a plate assembly 110 for allowing a golf bag 200 to be uprightly placed thereon, the plate assembly 110 having a front plate and a rear plate which are connected with each other; a support assembly 120 having a support rod 121 which is erected on the rear plate of the plate assembly 110 in a manner such that the golf bag 200 is fastened to and supported by the support rod 121; a front wheel section 130 having a front wheel 131 which is rotatably coupled to a front end of the front plate of the plate assembly 110 so that leftward and rightward cornering of the golf bag wheeling cart 100 is allowed; a rear wheel section 140 having a pair of rear wheels 141 which are rotatably coupled to both sides, respectively, of a rear end of the rear plate of the plate assembly 110; and a pulling assembly 150 joined to the front wheel section 130 for allowing the golf bag wheeling cart 100 to be pulled.

The front and rear plates of the plate assembly 110 are foldably connected with each other by folding means 112 such as a hinge, at a folding part 111 where approximately a middle portion of the front plate and a front end of the rear plate are commonly positioned, in a manner such that the front and rear plates of the plate assembly 110 are partially overlapped with each other. In a state wherein the front and rear plates of the plate assembly 110 are in an unfolded position, a rear portion of the front plate serves as an overlapped part 113 which is overlapped onto an upper surface of the rear plate and functions to horizontally maintain the front plate. In order to prevent the front plate from being unintentionally folded again onto the rear plate while being in the unfolded position, the overlapped part 113 is fastened to the rear plate by fastening means 114 such as a bolt and a nut. The front end of the front plate of the plate assembly 110 is formed with a curved guide part 115 which has an arc-shaped configuration, so that a placement level of the golf bag 200 on the plate assembly 110 is not raised due to the presence of the front wheel 131, whereby operational stability of the golf bag wheeling cart 100 according to the present invention is achieved.

In the support assembly 120 having the support rod 121 which is erected on the rear plate of the plate assembly 110, an upper holding bracket 122 is fastened to an upper end of the support rod 121 to fix an upper end of the golf bag 200. Here, the upper holding bracket 122 has a semi-circular configuration, and a first belt 122a is connected to both ends of the upper holding bracket 122. The first belt 122a has first locking means 122a. A U-shaped support member 125 is secured to the upper surface of the rear plate, and a lower end of the support rod 121 of the support assembly 120 is connected to the U-shaped support member 125 by a rotation pin 125a in a manner such that the support rod 121 can be collapsed onto the upper surface of the rear plate about the rotation pin 125a. A stopper pin 125b is removably fitted through both first side wall portions of the U-shaped support member 125 in front of the support rod 121 of the support assembly 120 in a manner such that the support rod 121 can be maintained in an erected status. An angle maintaining block 125c having a wedge-shaped configuration is fitted between the support rod 121 and a first bottom wall portion of the U-shaped support member 125, which first bottom wall portion connects the first side wall portions with each other, in a manner such that the erected support rod 121 can be selectively and slightly inclined forward, and thereby a center of gravity of the golf bag 200 uprightly placed on the rear plate of the plate assembly 110 is slightly shifted forward, whereby, when the golf bag wheeling cart 100 is moved along an upward slope, it is possible to prevent the golf bag wheeling cart 100 from being overturned rearward. Of course, it can be envisaged that a projected portion is integrally formed with the first bottom wall portion of the U-shaped support member 125 to slightly incline the support rod 121 forward. Also, in the support assembly 120, a lower holding bracket 123 is fastened to the upper surface of the rear plate of the plate assembly 110 in a widthwise direction of the rear plate to fix a lower end of the golf bag 200. Both ends of the lower holding bracket 123 are bent upward so that left and right portions of the golf bag 200 can be reliably supported by the lower holding bracket 123. A second belt 123a is connected to both ends of the lower holding bracket 123, which both ends are bent upward. The second belt 123a has second locking means 123b. A handle 124 is secured to the upper end of the support rod 121 of the support assembly 120, so that the handle 124 can be grasped upon moving the golf bag wheeling device 100 a little at a time, such as on a putting green. The support rod 121 comprises a plurality of first telescopic pipes which are inserted one into another and clamped one to another by virtue of a plurality of first clamping means 121a, so that a height of the support rod 121 can be adjusted depending upon a size of the golf bag 200 or a body figure of a user, or in conformity with user convenience. Here, it is preferred that the support rod 121 is composed of three telescopic pipes in consideration of user convenience upon performing a height adjustment task.

The front wheel section 130 includes a support bracket 132. The support bracket 132 has a U-shaped configuration and possesses both second side wall portions which extend downward and a second bottom wall portion. The front wheel 131 is rotatably coupled to the second side wall portions of the support bracket 132 by a shaft. Here, in the front wheel section 130, a hollow support housing 134 is seated on an upper surface of and adjacent to a front end of the curved guide part 115, and an angle adjusting shaft 133 is integrally formed with the second bottom wall portion of the support bracket 132, inserted through the hollow support housing 134, and mounted with respect to the front end of the curved guide part 115 formed at the front end of the front plate. Consequently, even when the golf bag wheeling cart 100 is used for an extended period of time, it is possible to prevent rotation force of the front wheel 131 from being reduced, and the front wheel 131 of the front wheel section 130 can be freely and smoothly rotated at all times. Free ends 132a of the second side wall portions of the support bracket 132 are bent rearward, and the front wheel 131 is rotatably coupled to the free ends 132a by the shaft. Due to this fact, when the golf bag wheeling cart 100 is pulled forward, a front part of the golf bag wheeling cart 100 is prevented from being raised from the ground.

The rear wheel section 140 includes a pair of guide pipes 142 which are affixed to a lower surface of and at the rear end of the rear plate and project leftward and rightward beyond both side surfaces, respectively, of the rear plate. One ends of a pair of slide shafts 143 are slidably inserted through the pair of guide pipes 142, respectively. The pair of rear wheels 141 are rotatably coupled to the other ends of the pair of slide shafts 143 in a manner such that a spacing between the rear wheels 141 can be changed. When the golf bag wheeling cart 100 is not used, a spacing between the rear wheels 141 can be decreased to a minimum. That is to say, a spacing between the rear wheels 141 can be appropriately adjusted as desired by the user. The one end of each slide shaft 143 is formed with a stopper projection 144 which functions to prevent the slide shaft 143 from being removed from the corresponding guide pipe 142.

The pulling assembly 150 includes a pulling rod 151 which is joined to the support bracket 132 of the front wheel section 130 by third locking means 152. The support bracket 132 is formed with a pair of engaging protrusions 154. The pair of engaging protrusions 154 are positioned in front of the third locking means 152, in a manner such that, when the pulling rod 151 is inclined forward by a predetermined angle, the pulling rod 151 is engaged with the engaging protrusions 154 and thereby prevented from being further inclined forward. Thus, upon movement along a slope, as the pulling rod 151 presses the front part of the golf bag wheeling cart 100 through the engaging protrusions 154, the front part of the golf bag wheeling cart 100 is prevented from being raised from the ground. Here, a hand grip 153 is formed at an upper end of the pulling rod 151 so that it can be conveniently grasped by the hand of the user. It is preferred that the pulling rod 151 is telescopically configured to be adequately adjusted in its height depending upon a body figure of the user or in conformity with user convenience. The pulling rod 151 is composed of a plurality of second telescopic pipes which are inserted one into another and clamped one to another by virtue of a plurality of second clamping means 155. It is preferred that, as in the case of the support rod 121, the pulling rod 151 is composed of three second telescopic pipes in consideration of user convenience upon performing a height adjustment task. The clamping means 155 comprises conventional means capable of clamping and unclamping the telescopic pipes one to and from another.

It is preferred that the golf bag wheeling cart 100 is made of aluminum or the like which can prevent corrosion and reduction of a weight of the golf bag wheeling cart 100.

Hereinafter, operations of the golf bag wheeling cart 100 according to the present invention, constructed as mentioned above, will be described in detail.

First, in the case that it is necessary to use the golf bag wheeling cart 100, the front plate of the plate assembly 110 which is in a folded status is unfolded from the rear plate to be horizontally maintained.

At this time, since the overlapped part 113 is overlapped onto the upper surface of the rear plate, even when a load is applied to the plate assembly 110, deformation of the plate assembly 110 is prevented.

The support rod 121 of the support assembly 120 is erected with respect to the U-shaped support member 125. The support rod 121 is held erected by the presence of the stopper pin 125b which is removably fitted through both first side wall portions of the U-shaped support member 125. Then, by fitting the angle maintaining block 125c between the support rod 121 and the first bottom wall portion of the U-shaped support member 125, the support rod 121 is slightly inclined forward.

Here, after erection of the support rod 121 is completed, a height of the support rod 121 which is composed of the plurality of first telescopic pipes is adjusted as desired by the user, and the first telescopic pipes are clamped one to another by the first clamping means 121a.

Also, in the pulling assembly 150, a height of the pulling rod 151 which is composed of the plurality of second telescopic pipes is adjusted as desired by the user, and the second telescopic pipes are clamped one to another by the second clamping means 155.

A spacing between the pair of rear wheels 141 of the rear wheel section 140 is also adjusted, as desired by the user, by sliding the rear wheels 141 leftward or rightward on the slide shafts 143.

After adjustment tasks of the golf bag wheeling cart 100 are completed, the golf bag 200 is placed on the plate assembly 110 in a manner such that the lower end of the golf bag 200 is laid on the lower holding bracket 123 and the golf bag 200 is brought into contact with the support rod 121. Next, the upper and lower ends of the golf bag 200 are fixed with respect to the upper and lower holding brackets 122 and 123 using the first and second belts 122a and 123a which respectively have first and second locking means 122b and 123b.

In this state, as the user grasps the grip 153 of the pulling rod 151 and pulls the golf bag wheeling cart 100, the golf bag wheeling cart 100 can be moved.

In the case that the golf bag wheeling cart 100 is moved along an upward slope, since the support rod 121 is slightly inclined forward and thereby the golf bag 200 is also slightly inclined forward, it is possible to prevent a center of gravity of the golf bag 200 having drivers, irons and putters from being moved rearward.

Upon climbing the upward slope, the likelihood of a center of gravity of the golf bag wheeling cart 100 including the golf bag 200 to be moved rearward is further decreased by the fact that the pulling rod 151 is engaged with the engaging protrusions 154 to press downward the front part of the golf bag wheeling cart 100.

Specifically, since the golf bag wheeling cart 100 has a simple construction, a manufacturing cost can be reduced. Also, because the golf bag 200 is substantially uprightly placed on the rear plate of the plate assembly 110, user convenience is improved upon selection of a golf club among the drivers, irons and putters, and the e go clubs are prevented from being prevented. Also, by the fact that the golf bag wheeling cart 100 can be selectively pulled or pushed in a state wherein the grip 153 of the pulling assembly 150 or the handle 124 of the support assembly 120 is grasped by the hand, it is possible to safely move the golf bag wheeling cart 100 even along an abrupt slope.

On the other hand, when it is desired to store the golf bag wheeling cart 100 in a place after use, the golf bag 200 is removed, and then, the support rod 121 and the pulling rod 151 are minimized in their heights. Thereafter, a spacing between the rear wheels 141 of the rear wheel section 140 is minimized, and the front and rear plates are folded with each other at the folding part 111 to reduce a volume occupied by the entire golf bag wheeling cart 100.

At this time, it is preferred that the pulling rod 151 is separately stored in a place.

### Industrial Applicability

As apparent from the above descriptions, the golf bag wheeling cart according to the present invention comprises a plate assembly for allowing a golf bag to be uprightly placed thereon, the plate assembly having a front plate and a rear plate which are connected with each other; a support assembly having a support rod which is erected on the rear plate of the plate assembly in a manner such that the golf bag is fastened to and supported by the support rod; a front wheel section having a front wheel which is rotatably coupled to a front end of the front plate of the plate assembly so that leftward and rightward cornering of the golf bag wheeling cart is allowed; a rear wheel section having a pair of rear wheels which are rotatably coupled to both sides, respectively, of a rear end of the rear plate of the plate assembly; and a pulling assembly joined to the front wheel section for allowing the golf bag wheeling cart to be pulled. As a consequence, the golf bag wheeling cart is decreased in its volume, and thereby can be easily moved to a golf course and stored in a place. Also, the golf bag wheeling cart is decreased in its weight, and thereby can be conveniently used even by an old or a feeble person. Further, since a golf bag is uprightly mounted to the golf bag wheeling cart, drivers, irons and putters can be selected and used in an easy and convenient manner. Moreover, the golf bag wheeling cart is constructed in such a way as to be safely and conveniently used.

1. A golf bag wheeling cart comprising:
a plate assembly for allowing a golf bag to be uprightly placed thereon, the plate assembly having a front plate and a rear plate which are connected with each other;
a support assembly having a support rod which is erected on the rear plate of the plate assembly in a manner such that the golf bag is fastened to and supported by the support rod;
a front wheel section having a front wheel which is rotatably coupled to a front end of the front plate of the plate assembly so that leftward and rightward cornering of the golf bag wheeling cart is allowed;
a rear wheel section having a pair of rear wheels which are rotatably coupled to both sides, respectively, of a rear end of the rear plate of the plate assembly; and
a pulling assembly joined to the front wheel section for allowing the golf bag wheeling cart to be pulled.

2. The golf bag wheeling cart as claimed in claim 1, wherein the front and rear plates of the plate assembly are foldably connected with each other by folding means at approximately a middle portion of the front plate and a front end of the rear plate, in a manner such that the front and rear plates of the plate assembly are partially overlapped with each other, with a rear portion of the front plate serving as an overlapped part which is fastened to the rear plate by fastening means.

3. The golf bag wheeling cart as claimed in claims 1 or 2, wherein the front end of the front plate is formed with a curved guide part which has an arc-shaped configuration, so that a placement level of the golf bag on the plate assembly is not raised due to the presence of the front wheel.

4. The golf bag wheeling cart as claimed in claim 1, wherein a U-shaped support member is secured to an upper surface of the rear plate; a lower end of the support rod of the support assembly is connected to the U-shaped support member by a rotation pin; a stopper pin is removably fitted through both first side wall portions of the U-shaped support member in front of the support rod of the support assembly; and an angle maintaining block having a wedge-shaped configuration is fitted between the support rod and a first bottom wall portion of the U-shaped support member, which first bottom wall portion connects the first side wall portions with each other, or a projected portion is integrally formed with the first bottom wall portion of the U-shaped support member.

5. The golf bag wheeling cart as claimed in claims 1 or 4, wherein the support assembly comprises an upper holding bracket which is fastened to an upper end of the support rod of the support assembly and has connected thereto a first belt for fixing an upper end of the golf bag, a lower holding bracket which is fastened to the upper surface of the rear plate of the plate assembly and has connected thereto a second belt for fixing a lower end of the golf bag; and a handle which is secured to the upper end of the support rod of the support assembly.

6. The golf bag wheeling cart as claimed in claims 1 or 4, wherein the support rod comprises a plurality of first telescopic pipes which are inserted one into another and clamped one to another by virtue of a plurality of first clamping means.

7. The golf bag wheeling cart as claimed in claim 1, wherein the front wheel section comprises a support bracket which has a U-shaped configuration and possesses both second side wall portions extending downward and a second bottom wall portion; the front wheel is rotatably coupled to the second side wall portions of the support bracket by a shaft; a hollow support housing is seated on an upper surface of and adjacent to a front end of the curved guide part; an angle adjusting shaft is integrally formed with the second bottom wall portion of the support bracket, inserted through the hollow support housing, and mounted with respect to the front end of the curved guide part formed at the front end of the front plate.

8. The golf bag wheeling cart as claimed in claim 7, wherein free ends of the second side wall portions of the support bracket are bent rearward, and the front wheel is rotatably coupled to the free ends by the shaft.

9. The golf bag wheeling cart as claimed in claim 1, wherein the rear wheel section comprises a pair of guide pipes which are affixed to a lower surface of and at the rear end of the rear plate and project leftward and rightward beyond both side surfaces, respectively, of the rear plate; one ends of a pair of slide shafts are slidably inserted through the pair of guide pipes, respectively; and the pair of rear wheels are rotatably coupled to the other ends of the pair of slide shafts in a manner such that a spacing between the rear wheels can be changed.

10. The gogolfg wheeling cart as claimed in claim 1, wherein the pulling assembly comprises a pulling rod which is joined to the support bracket of the front wheel section by locking means; and the support bracket is formed with a pair of engaging protrusions which are positioned in front of the locking means, in a manner such that, when the pulling rod is inclined forward by a predetermined angle, the pulling rod is engaged with the engaging protrusions and thereby prevented from being further inclined forward.

11. The golf bag wheeling cart as claimed in claim 10, wherein the pulling rod comprises a plurality of second telescopic pipes which are inserted one into another and clamped one to another by virtue of a plurality of second clamping means.
